(19) United States
(12) Patent Application Publication
(10) Pub. No.: US 2025/0097917 A1
(43) Pub. Date: Mar. 20, 2025

(54) TERMINAL, RADIO COMMUNICATION METHOD, AND BASE STATION

(71) Applicant: NTT DOCOMO, INC., Tokyo (JP)

(72) Inventors: Hiroki Harada, Chiyoda-ku, Tokyo (JP); Daisuke Kurita, Chiyoda-ku, Tokyo (JP); Mayuko Okano, Chiyoda-ku, Tokyo (JP); Kousuke Shima, Chiyoda-ku, Tokyo (JP); Masaya Okamura, Chiyoda-ku, Tokyo (JP); Tomoya Ohara, Chiyoda-ku, Tokyo (JP)

(73) Assignee: NTT DOCOMO, INC., Tokyo (JP)

(21) Appl. No.: 18/727,523

(22) PCT Filed: Jan. 14, 2022
(86) PCT No.: PCT/JP2022/001141

§ 371 Date: Jul. 9, 2024

(51) Int. Cl. H04W 72/0453; H04W 16/14

(52) U.S. Cl. CPC H04W 72/0453; H04W 16/14

(57) ABSTRACT

A terminal according to one aspect of the present disclosure includes a receiving section that receives first configuration information related to use of a frequency to which shared spectrum channel access is applied, and second configuration information for configuring a resource in which frequency division multiplexing of a downlink (DL) resource and an uplink (UL) resource is available, and a control section that controls, based on the first configuration information and the second configuration information, use of the resource in which the frequency division multiplexing is available in the frequency applied with the shared spectrum channel access. According to one aspect of the present disclosure, it is possible to enhance efficiency of resource use.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G);” “5G+ (plus),” “6th generation mobile communication system (6G),” “New Radio (NR),” “3GPP Rel. 15 (or later versions),” and so on) are also under study,

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, NR), it is assumed that a plurality of terminals (user terminals, User Equipments (UEs)) perform communication under ultra-high-density and high-traffic circumstances.

It is assumed that such circumstances are short of uplink (UL) resources as compared with downlink (DL) resources.

However, for NR specifications thus far, a method for increasing uplink resources has not been studied sufficiently. Unless the method is controlled appropriately, degradation in system performance, such as an increase in delay and degradation in coverage performance, may occur.

Thus, an object of the present disclosure is to provide a terminal, a radio communication method, and a base station that enhance efficiency of resource use.

### Solution to Problem

A terminal according to one aspect of the present disclosure includes a receiving section that receives first configuration information related to use of a frequency to which shared spectrum channel access is applied, and second configuration information for configuring a resource in which frequency division multiplexing of a downlink (DL) resource and an uplink (UL) resource is available, and a control section that controls, based on the first configuration information and the second configuration information, use of the resource in which the frequency division multiplexing is available in the frequency applied with the shared spectrum channel access, Advantageous Effects of Invention

According to one aspect of the present disclosure, it is possible to enhance efficiency of resource use.

### BRIEF DESCRIPTION OF DRAWINGS

FIGS. 1A and 1B are diagrams to show examples of configuration of a slot structure.

FIG. 2 is a diagram to show an example of a structure of XDD.

FIGS. 3A and 3B are diagrams to show examples of configuration of time domain and frequency domain resources for XDD operation.

FIG. 4 is a diagram to show an example of measurement in an XDD resource.

FIGS. 5A and 5B are diagrams to show examples of configuration of an XDD resource according to a first embodiment.

FIG. 6 is a diagram to show an example of a combination of DL reception and UL transmission that can be simultaneously transmitted and received, according to a second embodiment.

FIGS. 7A and 7B are diagrams to show examples of configuration of an XDD resource according to a third embodiment,

FIG. 8 is a diagram to show an example of a schematic structure of a radio communication system according to one embodiment.

FIG. 9 is a diagram to show an example of a structure of a base station according to one embodiment.

FIG. 10 is a diagram to show an example of a structure of a user terminal according to one embodiment.

FIG. 11 is a diagram to show an example of a hardware structure of the base station and the user terminal according to one embodiment.

FIG. 12 is a diagram to show an example of a vehicle according to one embodiment.

### DESCRIPTION OF EMBODIMENTS

### (Unlicensed Band)

In an unlicensed band (for example, 2.4 GHz band, 5 GHz band, 6 GHz band, or the like, which may be referred to as an unlicensed spectrum or a shared spectrum), it is assumed that, for example, a plurality of systems, such as Wi-Fi systems and systems (LAA systems) supporting Licensed-Assisted Access (LAA), coexist, and thus it is conceivable that avoidance of collision and/or control of interference of transmission between the plurality of systems is necessary.

In LAA in an existing LTE system (for example, Rel. 13), before data transmission in the unlicensed band, a data transmission apparatus performs listening to confirm the presence or absence of transmission by another apparatus (for example, a base station, a user terminal, a Wi-Fi apparatus, or the like), The listening may be referred to as Listen Before Talk (LBT), Clear Channel Assessment (CCA), carrier sense, channel sensing, sensing, channel access procedure, shared spectrum channel access procedure, energy detection (ED), or the like,

For example, the transmission apparatus may be a base station (for example, gNodeB (gNB), which may be referred to as a network (NW)) on downlink (DL), and may be a user terminal (UE) on uplink (UL). For example, a reception apparatus that receives data from the transmission apparatus may be a user terminal on DL, and may be a base station (NW) on UL.

In LAA in the existing LTE system, the transmission apparatus starts data transmission after a certain period (for example, immediately after or a backoff period) from detection of the absence of transmission by another apparatus (idle state) in LBT.

For future radio communication systems (also referred to as, for example, 5G, 5G+, New Radio (NR), 3GPP Rel. 15 (or later versions), or the like), use of the unlicensed band is also under study. An NR system using the unlicensed band may be referred to as an NR-Unlicensed (U) system, an NR LAA system, or the like.

NR-U may also include dual connectivity (DC) between a licensed band and the unlicensed band, stand-alone (SA) in the unlicensed band, and the like.

A node (for example, a base station or a UE) in NR-U starts transmission after confirming that a channel is idle by using LBT, to coexist with another system or another operator.

In NR-U, the base station (for example, qNB) or the UE acquires a transmission occasion (Transmission Opportunity (TxOP)) to perform transmission when an LBT result is idle. The base station or the UE does not perform transmission when an LBT result is busy (LBT-busy). Time of the transmission occasion may be referred to as channel occupancy time (COT).

Note that LBT-idle may be interpreted as LBT success. LBT-busy may be interpreted as LBT failure. (XDD)

For Rel-14 (or earlier versions) LTE, frequency division duplex (FDD) has been mainly implemented, and time division duplex (TDD) has also been supported.

On the other hand, for Rel-15 (or later versions) NR, TDD has been mainly studied, and FDD has also been supported together (for example, migration of LTE bands or the like).

In FDD, DL reception and UL transmission can be performed simultaneously, which is preferable in terms of delay reduction. On the other hand, in FDD, the ratio between DL resources and UL resources is fixed (for example, one to one).

In TDD, the ratio between DL resources and UL resources can be changed, and, for example, an increased amount of DL resources can enhance DL throughput in a typical environment with relatively large DL traffic.

On the other hand, considering the ratio between time for transmission and reception by TDD in Rel. 16 (or earlier versions), a case where transmission occasions for a UL signal/channel are less than reception occasions for a DL signal/channel is conceivable. In such a case, the UE fails to perform frequent UL signal/channel transmission, and there is a concern that delay in important UL signal/channel transmission occurs. Also, UL transmission occasions are less than DL reception occasions, and thus there is also a concern that a signal/channel in a UL transmission is busy. Furthermore, TDD limits time resources in which UL signal/channel transmission is available, and thus, for example, application of UL coverage enhancement technology using repetition transmission (Repetition) becomes limited.

For future radio communication systems (for example, Rel. 17/18 (or later versions)), it is studied that a division duplex method obtained by combining TDD with frequency division duplex (FDD) is introduced to UL and DL.

The division duplex method may be referred to as XDD (Cross Division Duplex). The XDD may mean a duplex method (in which DL and UL are available simultaneously) for frequency division multiplexing DL and UL in 1 component carrier (CC) or a plurality of CCs in a TDD band. When the duplex method is applied to a plurality of CCs, the XDD may mean that in a time resource with available DL in a certain CC, UL in another CC is available. The plurality of CCs may be CCs in an identical band.

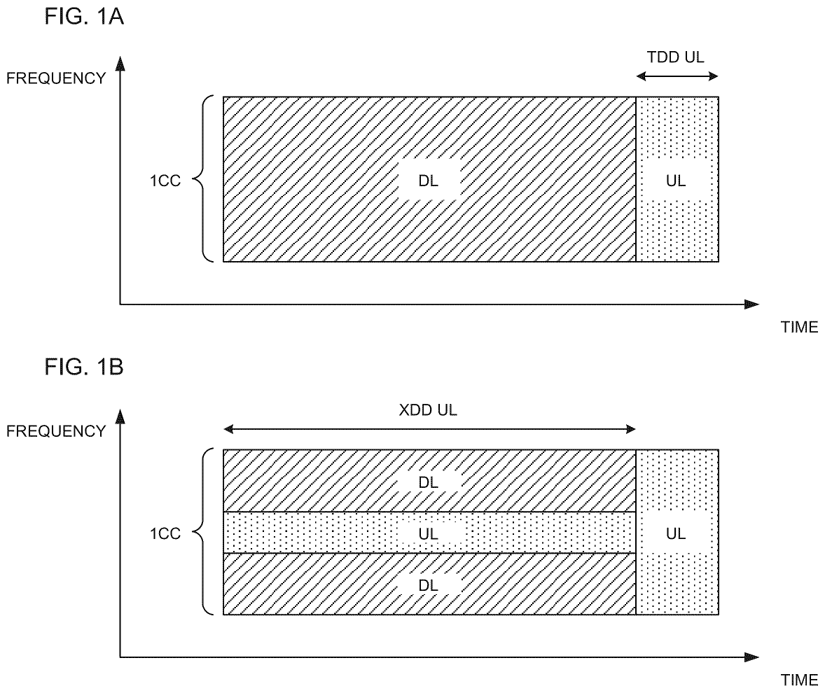

FIG. 1A is a diagram to show an example of configuration of the TDD defined in Rel. 16 (or earlier versions). In the example shown in FIG. 1A, for the UE, configuration of a slot/symbol for the TDD is performed in a bandwidth of one component carrier (CC) (which may be referred to as a cell or a serving cell).

In the example shown in FIG. 1A, the ratio between time of a DL slot and time of a UL slot is 4:1. In such slot/symbol configuration in conventional TDD, securing of sufficient UL time resources fails, and delay in UL transmission and degradation in coverage performance may occur,

FIG. 1B is a diagram to show an example of a structure of the XDD. In the example in FIG. 1B, a resource used for DL reception and a resource used for UL transmission temporally overlap each other in 1 component carrier (CC). According to such a resource structure, it is possible to secure a UL resource, and efficiency of resource use can be enhanced.

For example, as shown in the example shown in FIG. 1B, both ends of frequency domains in 1 CC are configured to be DLs, and these DLs are configured to sandwich a UL resource, thereby allowing occurrence of cross link interference (CLI) with neighboring carriers to be avoided and suppressed. In a boundary between a DL resource and a UL resource, a domain for guard may be configured.

Considering complexity of self-interference processing, it is conceivable that only a base station uses a DL resource and a UL resource simultaneously. In other words, in a resource with DL and UL temporally overlapping each other, a certain UE may use a DL resource, and another UE may use a UL resource,

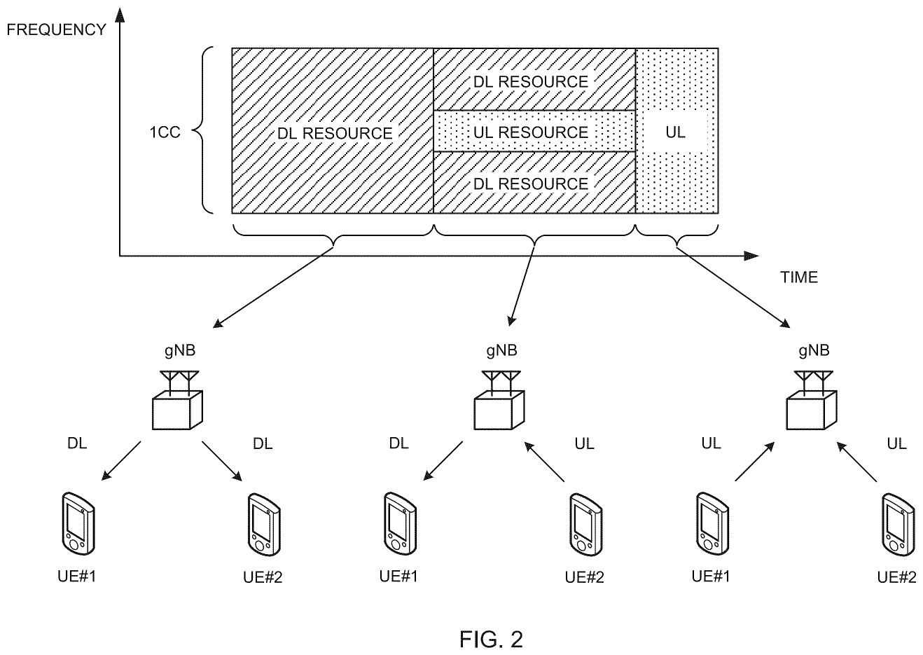

FIG. 2 is a diagram to show an example of a structure of the XDD. In the example shown in FIG. 2, a part of a DL resource in a TDD band is a UL resource, and DL and UL overlap each other partially and temporally.

In the example shown in FIG. 2, in a DL-only period, a plurality of UEs (in FIG. 2, UE #1 and UE #2) each receives a DL channel/signal.

In a period in which DL and UL temporally overlap each other, a certain UE (in the example in FIG. 2, UE #1) performs reception of a DL channel/signal, and another UE (in the example in FIG. 2, UE #2) performs transmission of a UL channel/signal. In this period, the base station performs simultaneous DL and UL transmission and reception.

Furthermore, in a UL-only period, each of the plurality of UEs transmits a UL channel/signal.

In existing NR (defined in, for example, Rel. 15/16 (or earlier versions)), a DL frequency resource and a UL frequency resource in a carrier for UE are configured as a DL bandwidth part (BWP) and a UL BWP, respectively. For switching from a DL/UL frequency resource to another DL/UL frequency resource, configuration of a plurality of BWPs and a mechanism for BWP adaptation are necessary.

In the existing NR, a time resource in a TDD carrier for UE is configured as at least one of DL, UL, and flexible (FL) in TDD configuration.

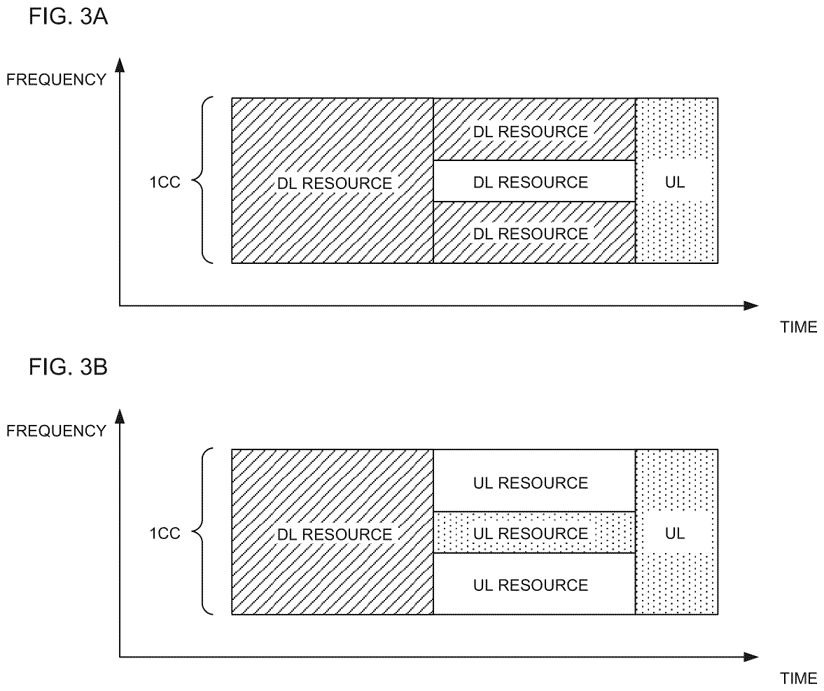

A method for configuring time domain and frequency domain resources for XDD operation is under study. For example, an XDD resource (period in which DL and UL overlap each other) is configured for UE #1 in FIG. 2, in a manner similar to that for an existing DL resource (for example, after avoiding use of a UL resource part by using frequency domain resource allocation (FDA)), thereby allowing an impact on a specification/UE to be minimized (see FIG. 3A).

For example, an XDD resource is configured for UE #2 in FIG. 2, in a manner similar to that for an existing UL resource (for example, after avoiding use of a DL resource part by using frequency domain resource allocation (FDRA)), thereby allowing an impact on a specification/UE to be minimized (see FIG. 3B).

Incidentally, it is conceivable that in the above XDD structure, a terminal performs measurement (which may be referred to as measurement operation).

However, when the measurement operation is performed in the XDD configuration, an issue may occur in resource management. For example, when at least one of a resource in which a DL reference signal (for example, at least one of a synchronization signal block (SSB) and a channel state information reference signal (CSI-RS), or the like) is transmitted and a resource in which received signal strength (for example, Received Signal Strength Indicator (RSSI)) measurement is performed is configured/indicated for a resource (particularly, a UL resource) in the XDD structure, the UE fails to simultaneously perform measurement operation and UL transmission operation.

Existing specifications (Rel. 16 (or earlier versions)) also define a case that UL transmission is not performed on a symbol in which the UE performs measurement.

On the other hand, when at least one of the resource in which the DL reference signal is transmitted and the resource in which received signal strength measurement is performed is configured/indicated for a DL resource in the XDD structure, the UE can perform measurement in the DL resource.

However, in this case, there is a concern that measurement in the DL resource in the XDD structure is affected by UL transmission/power from a neighboring UE.

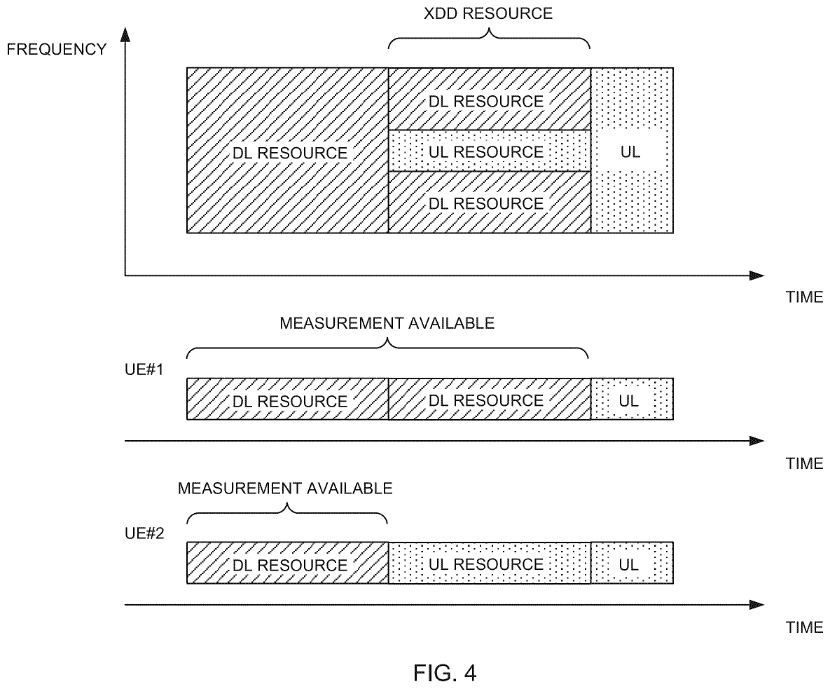

FIG. 4 is a diagram to show an example of the measurement in an XDD resource. In the example shown in FIG. 4, such an XDD resource for a plurality of UEs (UE #1 and UE #2) as that shown in FIG. 2 is configured. As shown in FIG. 2, in the XDD resource in FIG. 4, UE #1 performs DL reception and UE #2 performs UL transmission.

In the example shown in FIG. 4, time resources in which respective ones of UE #1 and UE #2 perform measurement are different from each other. In such a case, how to implement measurement operation has not been sufficiently studied.

For future radio communication systems (for example, Rel. 18/19 (or later versions)), it is also studied that a UE performs (supports) DL reception and UL transmission in the same time resource.

In the present disclosure, DL reception and UL transmission in the same time resource, transmission and reception for which a DL reception resource and a UL transmission resource are frequency division multiplexed (FDMed) with each other, simultaneous transmission and reception operation, simultaneous transmission and reception, full-duplex (FD) communication, subband non-overlapping full duplex, subband non-overlapping full-duplex communication, XDD, XDD communication, XDD operation, time and frequency division multiplexing, time and frequency division multiplexing communication, and time and frequency division multiplexing operation may be interchangeably interpreted.

The subband non-overlapping full-duplex communication may be performed in the above-mentioned XDD resource.

In a DL resource in the subband non-overlapping full-duplex communication, it is conceivable that the UE performs at least one of reception of data/control information from an arbitrary cell and measurement operation for a plurality of cells including peripheral cells.

In a UL resource in the subband non-overlapping full-duplex communication, it is conceivable that the UE performs at least one of transmission of data/control information to an arbitrary cell and transmission of a UL reference signal (for, for example, measurement) and a PRACH (for random access, for example).

For such subband non-overlapping full-duplex communication, a signal/channel that can be simultaneously transmitted and received by the UE has not been sufficiently studied.

For example, with respect to whether DL reception operation and UL transmission operation for measurement can be simultaneously performed and whether simultaneous data transmission and reception to and from a serving cell can be performed, whether functions required for the UE are common or different from each other has not been sufficiently studied. With respect to whether operations for transmission and DL reception of a UL reference signal/random access channel for measurement can be simultaneously performed, the operations using a beam different from data, and whether simultaneous data transmission and reception to and from a serving cell can be performed, whether functions required for the UE are common or different from each other has not been sufficiently studied.

It is studied that a band (TDD band) in which an XDD structure is used includes a frequency band of an unlicensed band (which may be referred to as an unlicensed TDD band, an NR-Unlicensed (U) system, or a shared spectrum).

However, a method for using XDD in a frequency of the unlicensed band has not been sufficiently studied.

For example, when XDD is used in a frequency of the unlicensed band, UL transmission started by the UE in some bands (frequency resources) during DL transmission by the base station may occur issues as follows:
When the UL transmission is started without LBT, interference occurs.
Received power of a DL channel/signal has an impact on a band in which an XDD resource is included and in which LBT is performed, and LBT for UL transmission fails.
Configuring a guard period (time resource)/guard subcarrier (frequency resource) for avoiding the above interference/LBT failure suppresses enhancement of efficiency of resource use.

Unless these studies are sufficiently performed, appropriate enhancement of resource use efficiency fails, and degradation in system performance may occur.

Thus, the inventors of the present invention came up with the idea of a method for resolving the above issues.

Embodiments according to the present disclosure will be described in detail with reference to the drawings as follows. The radio communication methods according to respective embodiments may each be employed individually, or may be employed in combination.

The present disclosure will be described below on the assumption that a “specific type” in the present disclosure is “ . . . ,” but is not limited to this. “ . . . ” in the present disclosure may mean any one of “ . . . ” or combination(s) of these (in other words, “ . . . ” may be interpreted as any one or combination(s) of these).

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like,

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a channel, a signal, a reference signal, and a channel/signal may be interchangeably interpreted. In the present disclosure, DL channel/signal reception, DL reception, and DL transmission may be interchangeably interpreted. In the present disclosure, UL channel/signal transmission, UL transmission, and UL reception may be interchangeably interpreted.

In the present disclosure, “support,” “supported,” “control,” “controllable,” “operate,” and “operable” may be interchangeably interpreted.

In the present disclosure, assuming/expecting that something is not “A” may be interpreted as not assuming/expecting that something is “A,” and vice versa.

### (Radio Communication Method)

An XDD resource may be configured/indicated for a UE by using at least one of higher layer signaling (RRC signaling/MAC CE) and physical layer signaling (DCI).

The higher layer signaling may be a specific RRC parameter/MAC CE field. The specific RRC parameter/MAC CE field may be an XDD configuration parameter, or may be a TDD configuration parameter.

In the present disclosure, the XDD resource may mean a resource in which a DL resource and a UL resource temporally overlap each other (are FDMed with each other). Overlap between the DL resource and the UL resource may mean that the DL resource and the UL resource entirely overlap each other, or may mean that the DL resource and the UL resource partially overlap each other.

In each embodiment of the present disclosure, measurement may mean at least one of Radio Resource Management (RRM) measurement, CLI measurement, measurement of system frame number (SFN) and frame timing difference, received power/reception quality (for example, L1-RSRP/SINR) measurement, channel state information (CSI) measurement, and measurement for positioning.

### First Embodiment

In a first embodiment, measurement operation in an XDD resource will be described.

A UE may assume/expect that an XDD resource is not configured in a specific time resource associated with a DL reference signal (for example, a DL reference signal for measurement). The UE may not assume/expect that the XDD resource is configured in a specific time resource associated with a DL reference signal (for example, a DL reference signal for measurement).

The specific time resource associated with the DL reference signal may be, for example, at least one of a time resource (for example, a symbol) to which the DL reference signal is mapped, a specific number of (for example, 1) earlier/later time resources (for example, symbols) including a time resource to which the DL reference signal is mapped, and a time resource (for example, a slot) including the DL reference signal.

The DL reference signal may be at least one of an SSB, a CSI-RS, a CSI-RS for mobility, a resource for RSSI measurement, and a PRS.

For example, a time resource for the DL reference signal may be configured by a higher layer parameter/DCI. In this case, the UE may assume that the XDD resource is not configured for the configured time resource for the DL reference signal (or a specific number of earlier/later time resources including the time resource, a slot including the time resource).

The UE may assume/expect that an XDD resource is configured in a specific time resource associated with a DL reference signal.

In this case, the UE may not perform measurement based on the DL reference signal overlapping the XDD resource in a time domain (or reporting of measurement based on the DL reference signal). The UE may not perform reception of the DL reference signal. The UE may ignore configuration/indication related to reception of the DI reference signal.

A time resource/XDD resource for a DL reference signal may be separately configured by a higher layer parameter/DCI. When the time resource for the DL reference signal partially overlaps the XDD resource, the UE may not perform measurement based on the DL reference signal (or reporting of measurement based on the DL reference signal). Alternatively, the UE may perform measurement based on some resources for the DL reference signal not overlapping the XDD resource (or reporting of measurement based on the some resources).

The UE may report UE capability information related to measurement in the XDD resource. The UE capability information may be defined as whether the UE can perform measurement in the XDD resource.

When reporting the UE capability information (for example, information indicating that measurement in the XDD resource is available), the UE may assume/expect that the XDD resource is configured in a specific time resource associated with a DL reference signal.

The specific time resource associated with the DL reference signal may be, for example, at least one of a time resource (for example, a symbol) to which the DL reference signal is mapped, a specific number of (for example, 1) earlier/later time resources (for example, symbols) including a time resource to which the DL reference signal is mapped, and a time resource (for example, a slot) including the DL reference signal.

The DL reference signal may be at least one of an SSB, a CSI-RS, a CSI-RS for mobility, a resource for RSSI measurement, and a PRS.

The UE may determine, based on specific higher layer signaling, whether to ignore configuration of an XDD resource overlapping a DL reference signal. When receiving a specific higher layer parameter, the UE may determine that configuration of the XDD resource overlapping the DL reference signal is ignored.

Note that the UE capability information may be defined for a specific frequency range (for example, FR2), or may be separately defined for each frequency range (for example, FR1/FR2 (FR2-1/FR2-2)).

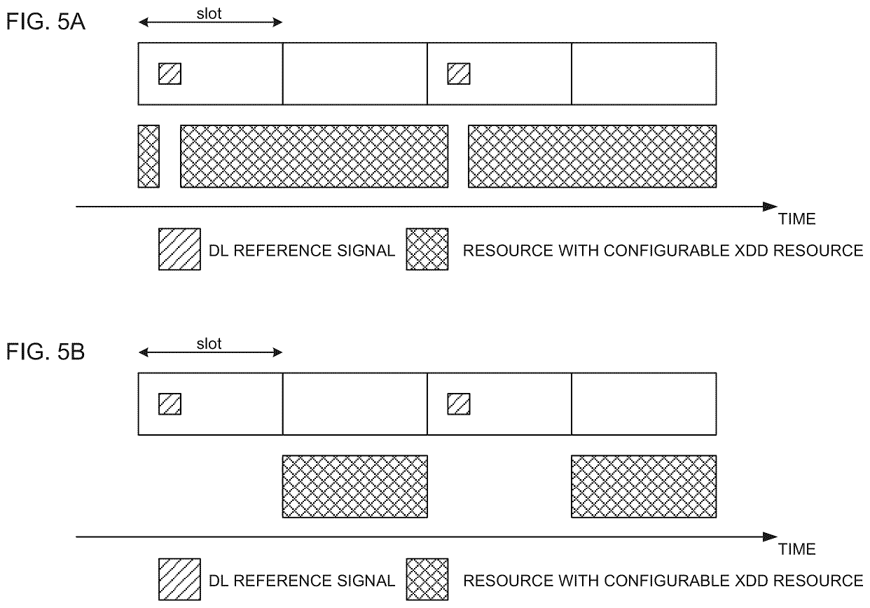

FIGS. 5A and 5B are diagrams to show examples of configuration of the XDD resource according to the first embodiment. In an example shown in FIG. 5A, the XDD resource is not configured in a symbol to which the DL reference signal is mapped. In the example shown in FIG. 5A, configuration of the XDD resource is available in a resource other than a symbol to which the DL reference signal is mapped.

In an example shown in FIG. 5B, the XDD resource is not configured in a slot to which the DL reference signal is mapped. In the example shown in FIG. 5B, configuration of the XDD resource is available in a resource other than a slot to which the DL reference signal is mapped.

According to the first embodiment above, it is possible to appropriately perform measurement operation even when using an XDD resource.

### Second Embodiment

In a second embodiment, UE capability information related to subband non-overlapping full duplex will be described.

A UE may report UE capability information related to subband non-overlapping full duplex to a network (for example, a base station).

The UE capability information may be defined as whether the UE supports subband non-overlapping full duplex.

The subband non-overlapping full duplex may be performed in an XDD resource.

The UE/base station may follow at least one of Embodiment 2-1 to Embodiment 2-3 below.

### Embodiment 2-1

For UE capability information related to subband non-overlapping full duplex, a combination of DL reception and UL transmission that can be simultaneously transmitted and received may be defined.

The DL reception may include reception of DL reception for measurement (DL reference signal for measurement).

When reporting the UE capability information related to subband non-overlapping full duplex, the UE may simultaneously perform DL reception and UL transmission for a predefined combination of DL reception and UL transmission.

### Embodiment 2-2

For UE capability information related to subband non-overlapping full duplex (first capability information), a combination of DL reception and UL transmission that can be simultaneously transmitted and received may be defined.

The DL reception may not include reception of DL reception for measurement (DL reference signal for measurement). In other words, the first capability information may not indicate that the DL reception for measurement and the UL transmission can be simultaneously performed.

When reporting the UE capability information related to subband non-overlapping full duplex, the UE may simultaneously perform DL reception and UL transmission for a predefined combination of DL reception and UL transmission,

In Embodiment 2-2, aside from the first capability information, UE capability information related to subband non-overlapping full duplex (second capability information) may be defined. The second capability information may indicate that DL reception including DL reception for measurement and UL transmission can be simultaneously performed.

### Embodiment 2-3

The UE may report, for UE capability information related to subband non-overlapping full duplex, whether to support a predefined combination of DL reception and UL transmission.

For example, for the UE capability information related to subband non-overlapping full duplex, the UE may report which combination of predefined combinations of DL reception and UL transmission is supported. In other words, the UE capability information related to subband non-overlapping full duplex may be defined as which combination of the predefined combinations of DL reception and UL transmission the UE supports.

For example, the combinations of DL reception and UL transmission may include a combination including reception of a DL reference signal for measurement. For example, the combinations of DL reception and UL transmission may include a combination including transmission of a UL reference signal for measurement (which may include a PRACH).

For example, capability information related to whether to support simultaneous transmission and reception of the combination including reception of the DL reference signal for measurement and capability information related to whether to support simultaneous transmission and reception of the combination including transmission of the UL reference signal for measurement (which may include a PRACH) may be defined as separate pieces of capability information, or may be defined as common capability information.

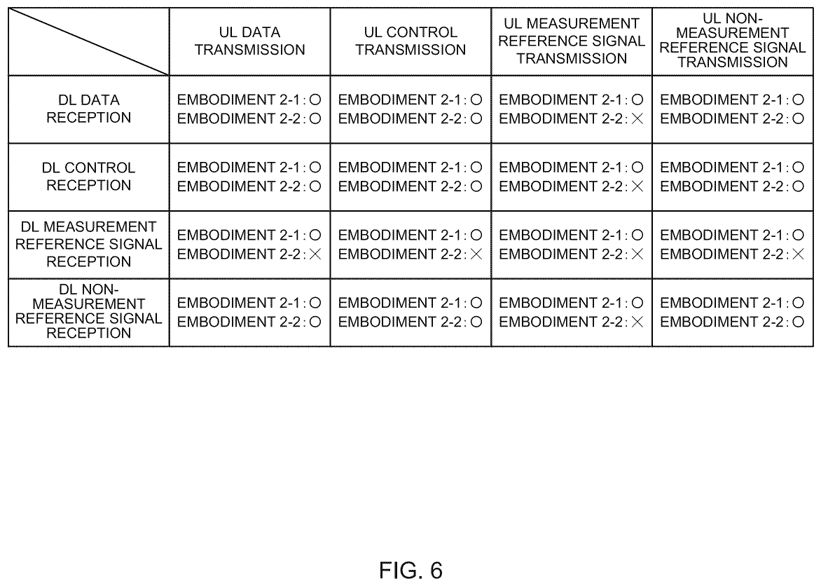

FIG. 6 is a diagram to show an example of the combination of DL reception and UL transmission that can be simultaneously transmitted and received, according to the second embodiment.

In Embodiment 2-1 mentioned above, the UE that reports the UE capability information related to subband non-overlapping full duplex may support all the combinations defined in a specification.

In Embodiment 2-2 mentioned above, the UE that reports the UE capability information related to subband non-overlapping full duplex (for example, the first capability information) may support a combination of all the combinations defined in a specification, the combination not including reception/transmission of a DL/UL reference signal for measurement.

In Embodiment 2-3 mentioned above, the UE that reports the UE capability information related to subband non-overlapping full duplex (for example, the first capability information) may support a specific combination of all the combinations defined in a specification.

In the example shown in FIG. 6, DL data reception, DL control reception, DL measurement reference signal reception, and DL non-measurement reference signal reception are defined as the DL reception, and UL data transmission, UL control transmission, UL measurement reference signal transmission, and UL non-measurement reference signal transmission are defined as the UL transmission.

In the present disclosure, the DL data reception may be interpreted as DL data, a PDSCH, or a signal transmitted by using a PDSCH, and vice versa.

In the present disclosure, the DL control reception may be interpreted as DL control information, a PDCCH, a CORESET, a search space set, DCI, or a signal transmitted by using a PDCCH, and vice versa.

In the present disclosure, the DL measurement reference signal reception may be interpreted as at least one of a DL measurement reference signal, a synchronization signal, a synchronization signal block, a cell-specific reference signal (CRS), a channel state information reference signal (CSI-RS), a CSI-RS for mobility, a demodulation reference signal (DMRS), a positioning reference signal (PRS), a phase tracking reference signal (PTRS), a tracking reference signal (TRS), and an RSSI measurement resource, and vice versa.

In the present disclosure, the DL non-measurement reference signal reception may be interpreted as at least one of a DL non-measurement reference signal, a synchronization signal, a synchronization signal block, a CRS, a CSI-RS, a CSI-RS for mobility, a DMRS, a PRS, a PTRS, and a TRS, and vice versa.

In the present disclosure, the UL data transmission may be interpreted as UL data, a PUSCH, or a signal transmitted by using a PUSCH, and vice versa.

In the present disclosure, the UL control transmission may be interpreted as UL control information, a PUCCH, a signal transmitted by using a PUCCH, or UCI, and vice versa.

In the present disclosure, the UL measurement reference signal transmission may be interpreted as at least one of a UL measurement reference signal, a sounding reference signal (SRS), a PRS, a demodulation reference signal (DMRS), a PRACH, a random access channel, and a PUSCH for a random access response, and vice versa.

In the present disclosure, the UL non-measurement reference signal transmission may be interpreted as at least one of an SRS, a PRS, a DMRS, a PRACH, a random access channel, and a PUSCH for a random access response, and vice versa.

In the example shown in FIG. 6, signs “∘” indicate supported cases, and signs “×” indicate unsupported cases.

In the example shown in FIG. 6, for Embodiment 2-1 mentioned above, simultaneous transmission and reception of arbitrary DL reception and UL transmission are supported.

In the example shown in FIG. 6, for Embodiment 2-2 mentioned above, simultaneous transmission and reception of a combination other than a combination including the DL measurement reference signal reception/UL measurement reference signal transmission are supported.

Note that, as in Embodiment 2-3 mentioned above, an arbitrary combination of the combinations shown in FIG. 6 may be supported, or may not be supported.

For example, even when reporting the UE capability information, the UE may not support the combination including the DL measurement reference signal reception. For example, even when reporting the UE capability information, the UE may not support the combination including the UL measurement reference signal transmission.

The UE may report UE capability information related to whether transmission and reception in a serving cell can be performed in a measurement gap. The capability information may be included in the above-mentioned UE capability information related to subband non-overlapping full duplex, or may be defined as capability information separate from the UE capability information related to subband non-overlapping full duplex.

According to the second embodiment above, it is possible to appropriately control measurement operation even when using subband non-overlapping full duplex.

### Third Embodiment

In a third embodiment, management of XDD using an unlicensed band (shared spectrum) will be described.

A UE may receive information for configuring/indicating use of the unlicensed band.

The third embodiment is subdivided into Embodiment 3-1 and Embodiment 3-2 described below. The UE may follow at least one method described in Embodiment 3-1 or Embodiment 3-2.

### Embodiment 3-1

In an unlicensed TDD band, an XDD resource may not be configured. In other words, the unlicensed TDD band may not be used in the XDD resource.

The UE may assume that the unlicensed TDD band is not used in the XDD resource.

In an unlicensed TDD band, an XDD resource may not be configured. In this case, the UE may receive, in the unlicensed TDD band, information related to execution of LBT (sensing). The information may be information for indicating that LBT is executed, or may be information for indicating that LBT is not executed.

In an unlicensed TDD band, an XDD resource may be configured. In this case, the UE may determine that LBT (sensing) and arbitrary UL transmission are not performed in the unlicensed TDD band.

### Embodiment 3-2

In an unlicensed TDD band, an XDD resource may be configured.

The UE may follow at least one of Embodiment 3-2-1 to Embodiment 3-2-3 described below.

### Embodiment 3-2-1

For the XDD resource in the unlicensed TDD band, FDM of DL resources/UL resources may be performed by using a width of a specific frequency resource.

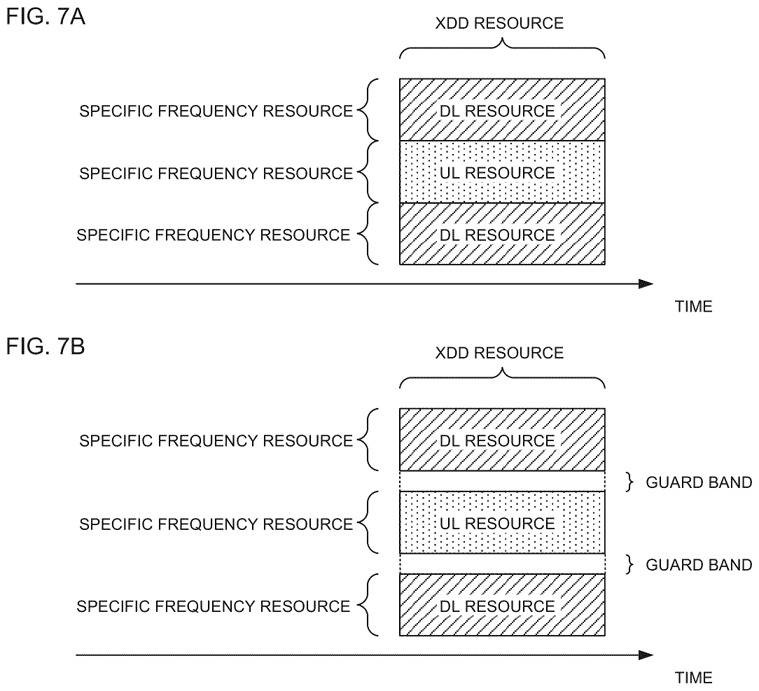

For the XDD resource in the unlicensed TDD band, a specific resource may be defined as a width of a frequency resource of a DL resource/UL resource (see FIG. 7A).

For the XDD resource in the unlicensed TDD band, the UE may assume/expect/determine that a specific resource is used as a width of a frequency resource of a DL resource/UL resource.

The specific resource may be a bandwidth in which LBT (sensing) is performed (for example, 20 MHZ width). The specific resource may be referred to as a resource block set (RB set).

### Embodiment 3-2-2

In addition to Embodiment 3-2-1 above, a guard band may be configured in a boundary between a DL resource and a UL resource in the XDD resource (see FIG. 7B).

A bandwidth of a frequency resource in the guard band may be predefined by a specification, or may be notified to the UE by higher layer signaling.

Note that in the present disclosure, the guard band, a guard frequency, a guard sub-carrier, and a frequency resource (band/sub-carrier) in which a resource is not configured may be interchangeably interpreted.

### Embodiment 3-2-3

For the XDD resource in the unlicensed TDD band, FDM of DL resources/UL resources may be performed by using a width of a specific frequency resource.

For the XDD resource in the unlicensed TDD band, a specific resource may be defined as a width of a frequency resource of a DL resource/UL resource.

For the XDD resource in the unlicensed TDD band, the UE may assume/expect/determine that a specific resource is used as a width of a frequency resource of a DL resource/UL resource.

The specific resource may be a bandwidth smaller than a bandwidth in which LBT (sensing) is performed (for example, 20 MHZ width). The specific resource may be a bandwidth smaller than a resource block set (RB set). In other words, in the bandwidth in which LBT (sensing) is performed (for example, 20 MHz width), a DL resource and a DL resource may be FDMed with each other.

At least one of Embodiment 3-1 and Embodiment 3-2 above may be applied in common to a first unlicensed band (for example, an unlicensed band of the 60 GHz band) and a second unlicensed band (for example, an unlicensed band of the 5/6 GHz band).

At least one of Embodiment 3-1 and Embodiment 3-2 above may be separately applied to each of the first unlicensed band (for example, the unlicensed band of the 60 GHz band) and the second unlicensed band (for example, the unlicensed band of the 5/6 GHZ band).

For example, in the first unlicensed band, configuration of an XDD resource may be allowed in a case of channel access without LBT (sensing).

Either of Embodiment 3-1 and Embodiment 3-2 above may be applied based on whether the UE supports simultaneous transmission and reception (for example, whether the UE reports UE capability information related to subband non-overlapping full duplex). For example, when the UE supports simultaneous transmission and reception, Embodiment 3-2 above may be applied.

According to the third embodiment above, it is possible to prevent occurrence of inappropriate interference by XDD management in an unlicensed band.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

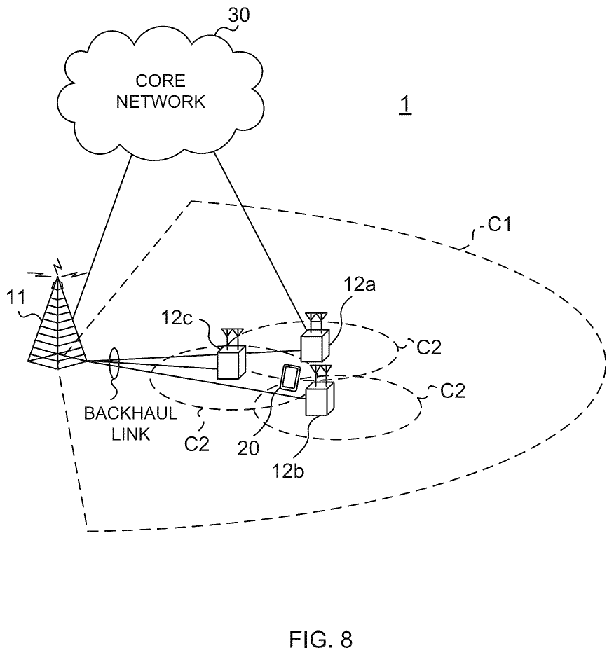

FIG. 8 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (qNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FRI may be a frequency band of 6 GHz or less (sub-6 GHz), and FR2 may be a frequency band which is higher than 24 GHZ (above-24 GHz), Note that frequency bands, definitions and so on of FRI and FR2 are by no means limited to these, and for example, FRI may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node,”

The base station 10 may be connected to a core network 30 through another base station 10 or directly. For example, the core network 30 may include at least one of Evolved Packet Core (EPC), 5G Core Network (5GCN), Next Generation Core (NGC), and so on,

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DET-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels,

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

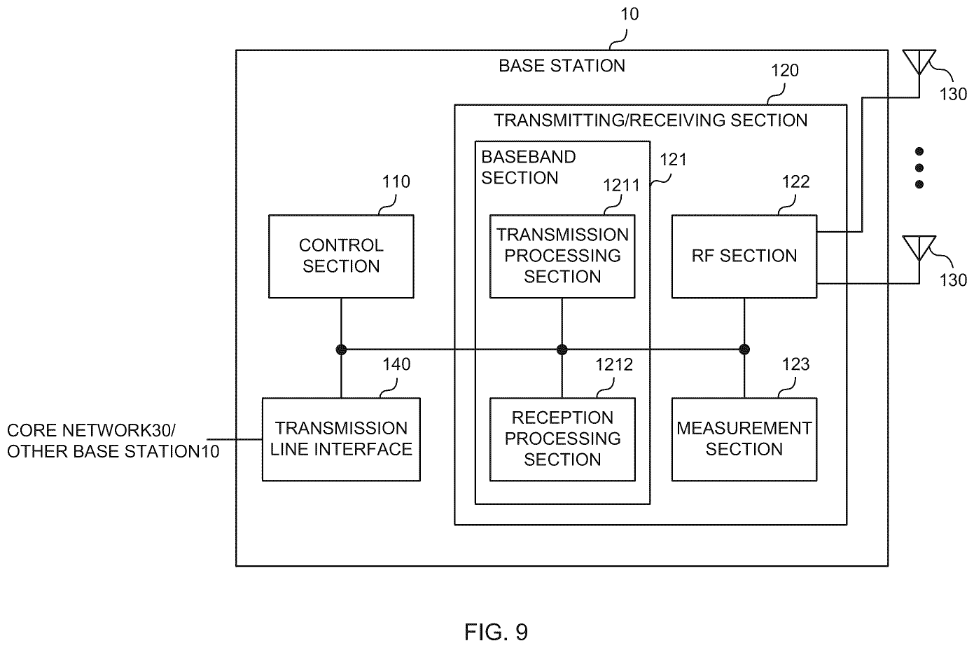

FIG. 9 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit configuration information about a resource (XDD resource) in which frequency division multiplexing of a downlink (DL) resource and an uplink (UL) resource is available, and information related to a time resource for a DL reference signal for measurement. The control section 110 may configure measurement based on the DL reference signal for measurement by using at least one of the configuration information about the resource, the information related to the time resource, and reporting of capability information related to measurement of the DL reference signal for measurement (first embodiment).

The transmitting/receiving section 120 may receive capability information indicating whether simultaneous transmission and reception of a specific downlink (DL) signal and a specific uplink (UL) signal is available. The control section 110 may control simultaneous transmission and reception of the specific DL signal and the specific UL signal in a resource (XDD resource) in which frequency division multiplexing of a DL resource and a UL resource is available (second embodiment).

The transmitting/receiving section 120 may transmit first configuration information related to use of a frequency to which shared spectrum channel access is applied, and second configuration information for configuring a resource (XDD resource) in which frequency division multiplexing of a downlink (DL) resource and an uplink (UL) resource is available. The control section 110 may configure, by using the first configuration information and the second configuration information, use of the resource in which frequency division multiplexing is available in the frequency to which the shared spectrum channel access is applied (third embodiment).

### (User Terminal)

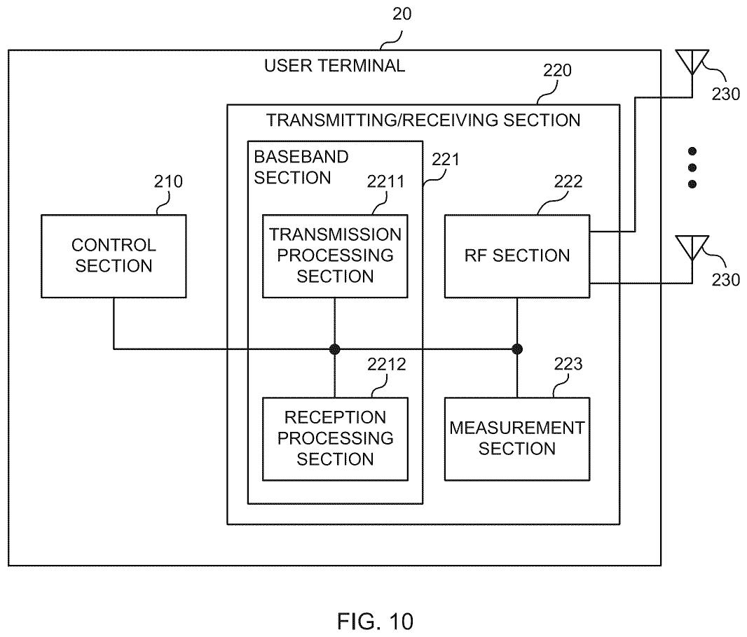

FIG. 10 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DET processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-S-OFDM waveform if transform precoding is enabled, and otherwise, does not need to perform the DET processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDET processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive configuration information about a resource (XDD resource) in which frequency division multiplexing of a downlink (DL) resource and an uplink (UL) resource is available, and information related to a time resource for a DL reference signal for measurement. The control section 210 may control measurement based on the DL reference signal for measurement, based on at least one of the configuration information about the resource, the information related to the time resource, and reporting of capability information related to measurement of the DL reference signal for measurement (first embodiment),

The control section 210 may assume that the resource in which frequency division multiplexing is available is not configured in a resource for the DL reference signal for measurement (first embodiment).

When a resource for the DL reference signal for measurement and the resource in which frequency division multiplexing is available overlap each other in a time domain, the control section 210 may control so as not to perform measurement based on the resource for the DL reference signal for measurement in the overlapped time domain (first embodiment).

When reporting capability information related to measurement of the DL reference signal for measurement, the control section 210 may assume that the resource in which frequency division multiplexing is available can be configured in a time resource for the DL reference signal for measurement (first embodiment).

The transmitting/receiving section 220 may transmit capability information indicating whether simultaneous transmission and reception of a specific downlink (DL) signal and a specific uplink (UL) signal is available. The control section 210 may control simultaneous transmission and reception of the specific DL signal and the specific UL signal in a resource (XDD resource) in which frequency division multiplexing of a DL resource and a UL resource is available (second embodiment).

The specific DL signal may be an arbitrary DL signal, and the specific UL signal may be an arbitrary UL signal (second embodiment).

The specific DL signal may be a DL signal not including a DL reference signal for measurement, and the specific UL signal may be a UL signal not including a UL reference signal for measurement (second embodiment).

The transmitting/receiving section 220 may transmit another piece of capability information indicating whether at least one of reception of the specific DL signal and transmission of the specific UL signal is available in a serving cell during a measurement gap period (second embodiment).

The transmitting/receiving section 220 may receive first configuration information related to use of a frequency to which shared spectrum channel access is applied, and second configuration information for configuring a resource (XDD resource) in which frequency division multiplexing of a downlink (DL) resource and an uplink (UL) resource is available. The control section 210 may control, based on the first configuration information and the second configuration information, use of the resource in which frequency division multiplexing is available in the frequency to which the shared spectrum channel access is applied (third embodiment).

The control section 210 may assume that the resource in which frequency division multiplexing is available is not configured in a resource (unlicensed TDD band) configured by the first configuration information (third embodiment).

The control section 210 may assume that the resource in which frequency division multiplexing is available is configured in a resource configured by the first configuration information. The DL resource and the UL resource may have a common specific bandwidth (third embodiment).

The control section 210 may assume that the resource in which frequency division multiplexing is available is configured in a resource configured by the first configuration information. The DL resource and the UL resource may have a common specific bandwidth, and a guard frequency resource may be configured in a boundary between the DL resource and the UL resource (third embodiment),

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

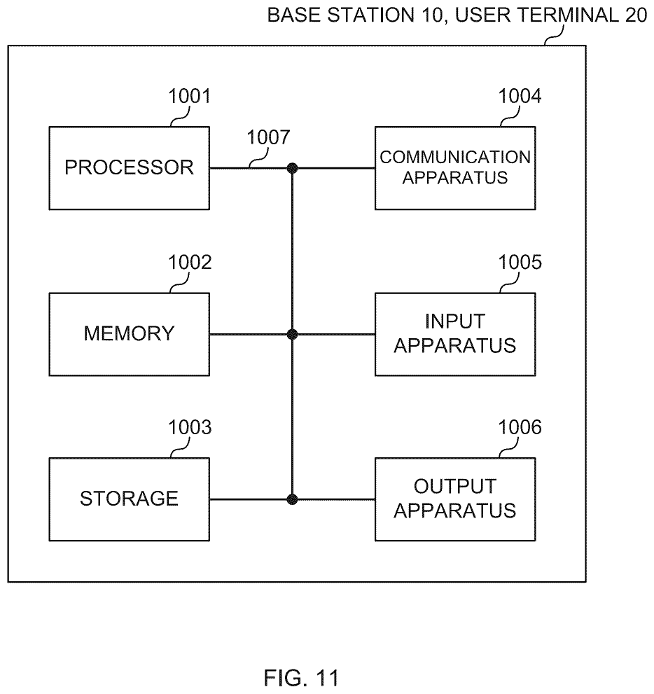

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on,

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on, Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), System information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media,

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “GNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

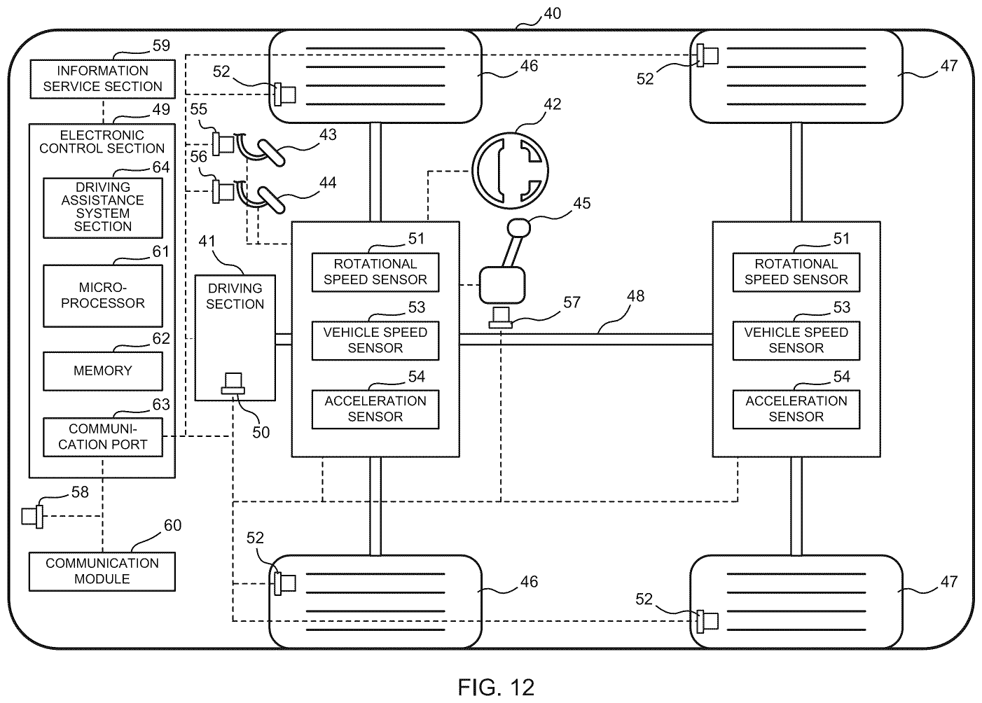

FIG. 12 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU),

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on,

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives first configuration information related to use of a frequency to which shared spectrum channel access is applied, and second configuration information for configuring a resource in which frequency division multiplexing of a downlink (DL) resource and an uplink (UL) resource is available; and
a control section that controls, based on the first configuration information and the second configuration information, use of the resource in which the frequency division multiplexing is available in the frequency applied with the shared spectrum channel access.

2. The terminal according to claim 1, wherein
the control section assumes that the resource in which the frequency division multiplexing is available is not configured in a resource configured by the first configuration information.

3. The terminal according to claim 1, wherein
the control section assumes that the resource in which the frequency division multiplexing is available is configured in a resource configured by the first configuration information, and
the DL resource and the UL resource have a common specific bandwidth.

4. The terminal according to claim 1, wherein
the control section assumes that the resource in which the frequency division multiplexing is available is configured in a resource configured by the first configuration information, and
the DL resource and the UL resource have a common specific bandwidth, and a guard frequency resource is configured in a boundary between the DL resource and the UL resource.

5. A radio communication method for a terminal, the radio communication method comprising:
receiving first configuration information related to use of a frequency to which shared spectrum channel access is applied, and second configuration information for configuring a resource in which frequency division multiplexing of a downlink (DL) resource and an uplink (UL) resource is available; and
controlling, based on the first configuration information and the second configuration information, use of the resource in which the frequency division multiplexing is available in the frequency applied with the shared spectrum channel access.

6. A base station comprising:
a transmitting section that transmits first configuration information related to use of a frequency to which shared spectrum channel access is applied, and second configuration information for configuring a resource in which frequency division multiplexing of a downlink (DL) resource and an uplink (UL) resource is available; and
a control section that configures, by using the first configuration information and the second configuration information, use of the resource in which the frequency division multiplexing is available in the frequency applied with the shared spectrum channel access.
